(19) United States
(12) Patent Application Publication
(10) Pub. No.: US 2016/0065953 A1
(43) Pub. Date: Mar. 3, 2016

(54) IMAGE PROCESSING METHOD AND APPARATUS

(71) Applicant: Samsung Electronics Co., Ltd., Suwon-si (KR)

(72) Inventors: Jingu HEO, Yongin-si (KR); Seok LEE, Hwaseong-si (KR); Dong Kyung NAM, Yongin-si (KR); Juyong PARK, Seongnam-si (KR)

(21) Appl. No.: 14/624,950

(22) Filed: Feb. 18, 2015

(30) Foreign Application Priority Data
Aug. 28, 2014 (KR) 10-2014-0113419

(51) Int. Cl. H04N 13/04

(52) U.S. Cl. CPC H04N 13/047

(57) ABSTRACT

An image processing method includes tracking users viewing a three-dimensional (3D) image displayed on a screen, and generating a 3D image on the screen for each of a plurality of regions based on a result of the tracking, the plurality of regions being formed based on a number of the users is disclosed.

### CROSS-REFERENCE TO RELATED APPLICATION

This application claims the priority benefit of Korean Patent Application No. 10-2014-0113419, filed on Aug. 28, 2014, in the Korean Intellectual Property Office, the disclosure of which is incorporated herein by reference in its entirety.

### BACKGROUND

1. Field

At least one example embodiment relates to an image processing technology and, more particularly, to methods and/or apparatuses for processing a plurality of three-dimensional (3D) images output to a plurality of regions divided on a screen.

2. Description of the Related Art

Recently, an image device for providing a three-dimensional (3D) image to be viewed by a user while not requiring an additional device such as 3D glasses has been developed. As an example, an optical lens disposed on a front side of a display panel included in the image device may divide an image into an image to be projected onto a left eye of the user and an image to be projected onto a right eye of the user. Using this scheme, the user may recognize a 3D image without wearing the 3D glasses.

A 3D effect of the 3D image may be experienced differently by the user according to the user's position. For example, the user may view the 3D image without recognizing artifacts or cross talk while being located at an optimal viewing zone for the 3D image.

If there are a plurality of users viewing the 3D image, a portion of the users are not located at the optimal viewing zone of the 3D image may experience the artifacts or crosstalk while viewing the 3D image, which may degrade the 3D effect of the 3D image.

### SUMMARY

At least one example embodiment relates to an image processing method.

According to at least one example embodiment, an image processing method includes tracking users viewing a three-dimensional (3D) image displayed on a screen, and generating a 3D image on the screen for each of a plurality of regions based on a result of the tracking, the plurality of regions being formed based on a number of the users.

According to at least one example embodiment, if a user associated with a first region of the plurality of regions is located at a desired position for viewing a 3D image of a second region of the plurality of regions, the generating generates a 3D image associated with the second region in a merged region by merging the first region and the second region.

According to at least one example embodiment, the image processing method may further include instructing a user associated with a first region, to move to a desired position for viewing a 3D image of a second region in the plurality of regions if the user is not located at the desired position.

According to at least one example embodiment, if the user moves to the desired position, a 3D image associated with the second region may be generated in a merged region by merging the first region with the second region.

According to at least one example embodiment, contents of an image associated with the first region may be identical to contents of an image associated with the second region.

According to at least one example embodiment, the 3D image associated with the second region may be a main image.

According to at least one example embodiment, a user associated with the second region may be a main user.

According to at least one example embodiment, the method includes determining whether the user is located at the desired position based on whether the user recognizes an artifact.

According to at least one example embodiment, the method includes outputting, to the user, an indicator instructing the user to move to the desired position such that the user is aware of a location of the desired position.

According to at least one example embodiment, if all of the users are located at a desired position for viewing a 3D image, the generating generates the 3D image as though the plurality of regions is a single region.

According to at least one example embodiment, the plurality of regions may have different forms based on at least one of contents in the 3D image, the number of users viewing the 3D image, a distance between the screen and each of the users viewing the 3D image, and selections of the users viewing the 3D image.

At least one example embodiment relates to an image processing apparatus.

According to at least one example embodiment, an image processing apparatus includes a user determiner configured to track users viewing a 3D image displayed on a screen, and an image generator configured to generate a 3D image on the screen for each of a plurality of based on a result of the tracking, the plurality of regions being formed based on a number of the users.

According to at least one example embodiment, if a user associated with a first region is located at a desired position for viewing a 3D image of a second region in the regions, the image generator may be configured to generate a 3D image associated with the second region in a merged region by merging the first region with the second region.

According to at least one example embodiment, the image processing apparatus may further include an instructor configured to instruct a user associated with a first region of the plurality of regions, to move to a desired position for viewing a 3D image of a second region of the plurality of regions if the user is not located at the desired position.

According to at least one example embodiment, if the user moves to the desired position, the image generator may be configured to generate a 3D image associated with the second region in a merged region by merging the first region with the second region.

According to at least one example embodiment, the user determiner may be configured to determine that the 3D image associated with the second region is a main image.

According to at least one example embodiment, the user determiner may be configured to determine that a user associated with the second region is a main user.

According to at least one example embodiment, if all of the users are located at a desired position for viewing a 3D image, the image generator may be configured to generate the 3D image as though the plurality of regions is a single region.

Additional aspects of example embodiments will be set forth in part in the description which follows and, in part, will be apparent from the description, or may be learned by practice of inventive concepts.

### BRIEF DESCRIPTION OF THE DRAWINGS

These and/or other aspects will become apparent and more readily appreciated from the following description of example embodiments, taken in conjunction with the accompanying drawings of which:

FIG. 1 illustrates an example of an image processing apparatus according to at least one example embodiment;

FIG. 2 illustrates an example of an image processing method according to at least one example embodiment;

FIG. 3 illustrates another example of an image processing method according to at least one example embodiment;

FIG. 4 illustrates an example of a method of generating a three-dimensional (3D) image in a merged region according to at least one example embodiment;

FIG. 5 illustrates an example of a method of determining a main image among 3D images generated on a screen according to at least one example embodiment;

FIG. 6 illustrates an example of a method of determining a main user among a plurality of users viewing a 3D image generated on a screen according to at least one example embodiment;

FIG. 7 illustrates still another example of an image processing method according to at least one example embodiment;

FIGS. 8A and 8B illustrate examples of an image processing method and a method of generating a 3D image in a merged region according to at least one example embodiment;

FIG. 9 illustrates an example of a method of instructing a user to move to a desired (or alternatively, predetermined) position for viewing a 3D image according to at least one example embodiment; and

FIGS. 10A and 10B illustrate examples of a method of generating 3D images in regions divided on a screen and a method of generating a 3D image in a merged region according to at least one example embodiment.

### DETAILED DESCRIPTION OF EXAMPLE EMBODIMENTS

Inventive concepts will now be described more fully with reference to the accompanying drawings, in which example embodiments of are shown. These example embodiments are provided so that this disclosure will be thorough and complete, and will fully convey inventive concepts of to those skilled in the art. Inventive concepts may be embodied in many different forms with a variety of modifications, and a few embodiments will be illustrated in drawings and explained in detail. However, this should not be construed as being limited to example embodiments set forth herein, and rather, it should be understood that changes may be made in these example embodiments without departing from the principles and spirit of inventive concepts, the scope of which are defined in the claims and their equivalents. Like numbers refer to like elements throughout. In the drawings, the thicknesses of layers and regions are exaggerated for clarity.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Specific details are provided in the following description to provide a thorough understanding of example embodiments. However, it will be understood by one of ordinary skill in the art that example embodiments may be practiced without these specific details. For example, systems may be shown in block diagrams so as not to obscure example embodiments in unnecessary detail. In other instances, well-known processes, structures and techniques may be shown without unnecessary detail in order to avoid obscuring example embodiments.

In the following description, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware in existing electronic systems (e.g., electronic imaging systems, image processing systems, digital point-and-shoot cameras, personal digital assistants (PDAs), smartphones, tablet personal computers (PCs), laptop computers, etc.). Such existing hardware may include one or more Central Processing Units (CPUs), digital signal processors (DSPs), application-specific-integrated-circuits (ASICs), field programmable gate arrays (FPGAs) computers or the like.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium”, “computer readable storage medium” or “non-transitory computer readable storage medium” may represent one or more devices for storing data, including read only memory (ROM), random access memory (RAM), magnetic RAM, core memory, magnetic disk storage mediums, optical storage mediums, flash memory devices and/or other tangible or non-transitory machine readable mediums for storing information. The term “computer-readable medium” may include, but is not limited to, portable or fixed storage devices, optical storage devices, and various other tangible or non-transitory mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors may be programmed to perform the necessary tasks, thereby being transformed into special purpose processor(s) or computer(s).

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “includes”, “including”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which inventive concepts belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “and/or” includes any and all combinations of one or more of the associated listed items. Expressions such as “at least one of,” when preceding a list of elements, modify the entire list of elements and do not modify the individual elements of the list.

Reference will now be made in detail to example embodiments, which are illustrated in the accompanying drawings and wherein like reference numerals refer to like elements throughout.

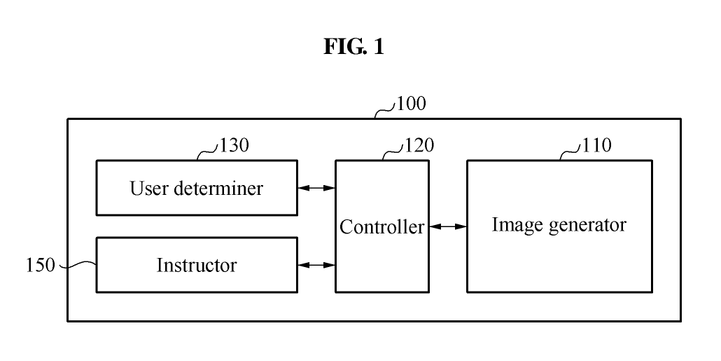

FIG. 1 illustrates an image processing apparatus 100 according to at least one example embodiment.

Referring to FIG. 1, the image processing apparatus 100 may generate a three-dimensional (3D) image in regions divided on a screen by appropriately processing the 3D image to be provided to a plurality of users.

The processed 3D image may be an image processed such that a user senses a 3D effect at a desired (or alternatively, predetermined) position without recognizing an artifact. The desired (or alternatively, predetermined) position may be a position optimized for viewing the 3D image and thus, the user may sense the 3D effect at the desired (or alternatively, predetermined) position without recognizing the artifact.

The image processing apparatus 100 includes an image generator 110, a controller 120, a user determiner 130, and an instructor 150.

The image processing apparatus 100 may also include an image output unit including a display panel used as a screen. The display panel of the image output unit may include a plurality of pixels. The image output unit may be, for example, a liquid crystal display (LCD), a plasma display panel (PDP) device, and an organic light emitting diodes (OLED) display device. The image output unit may output an image generated by the image generator 110.

The image generator 110 may generate an image by rendering the image.

The image generator 110 may be, for example, a device for transmitting data on a 3D image processed to be generated on a screen to a display device including a screen or a display panel.

The image generator 110 may generate, on the screen, the 3D image appropriately processed to be viewed by the plurality of users. For example, the image generator 110 may generate at least one 3D image appropriately processed to be viewed by the users, for each of regions divided on the screen.

The image generator 110 may also generate an independent 3D image for each of the regions divided on the screen.

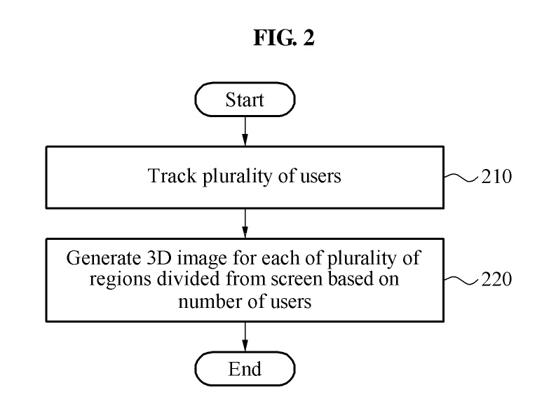

Descriptions about a method of dividing a region on a screen into a plurality of regions, and a method of generating a 3D image for each of the plurality of regions will also be provided with reference to FIGS. 2 through 10.

The controller 120 may control configurations, for example, the image generator 110, the user determiner 130, and the instructor 150 of the image processing apparatus 100. The controller 120 may appropriately process a 3D image to be processed by the image generator 110 so as to be viewed by a user. Also, the controller 120 may perform an operation required for the processing. The controller 120 may be, for example, at least one processor for processing the operation or at least one core included in a processor (i.e., a special purpose computer processor). The controller 120 may be, for example, a central processing unit (CPU), a graphics processing unit (GPU), and at least one core included in the CPU or the GPU.

The user determiner 130 may track a position of a user viewing the 3D image generated by the image generator 110. For example, the user determiner 130 may track a position for each of a plurality of users viewing 3D images generated on a plurality of regions divided on a screen.

As an example, the user determiner 130 may identify the position of the user by tracking eyes, a face, a torso, and/or other body parts of the user.

The user determiner 130 may be a device for identifying or tracking a position of a user viewing a 3D image. For example, the user determiner 130 may include at least one of a device for recognizing both eyes and a position detecting sensor, and at least one sensor for identifying or tracking a position of a user.

The image generator 110 may divide the screen into the plurality of regions to be appropriately viewed by each of the users based on identified or tracked positions of the users, and may generate the 3D image appropriately processed based on a position of each of the users, for each of the divided regions.

The user determiner 130 may determine whether the user is located at a desired (or alternatively, predetermined) position for viewing the 3D image generated for each of the divided regions, by identifying or tracking the position of the user. The desired (or alternatively, predetermined) position may be a position at which the user may view the generated 3D image without recognizing the artifact. For example, the desired (or alternatively, predetermined) position may be an optimal viewing zone for viewing a 3D image.

The user determiner 130 may determine a main user among the users viewing the 3D images generated by the image generator 110 in the divided regions on the screen. Descriptions about a method of determining the main user among the users viewing the generated 3D images using the user determiner 130 will also be provided with reference to FIG. 6.

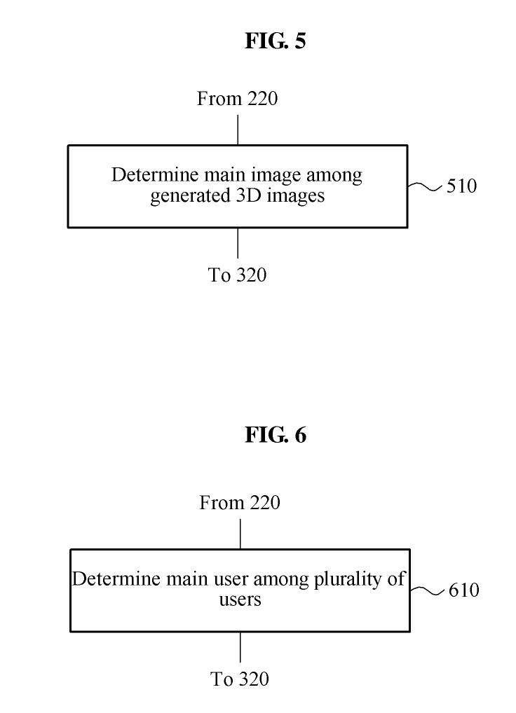

The user determiner 130 may determine the main image among the 3D images generated by the image generator 110 in the divided regions on the screen. Descriptions about a method of determining the main image among the generated 3D images using the user determiner 130 will also be provided with reference to FIG. 5.

The instructor 150 may instruct the user to move to the desired (or alternatively, predetermined) position for viewing the 3D images generated for each of the divided regions of the screen by the image generator 110. For example, when another main user different from the main user determined by the user determiner 130 is to view a 3D image being viewed by the main user, the other user may recognize an artifact with respect to the 3D image being viewed by the main user. In this example, the instructor 150 may instruct the other user to move to a desired (or alternatively, predetermined) position such that the other user views the 3D image without recognizing the artifact.

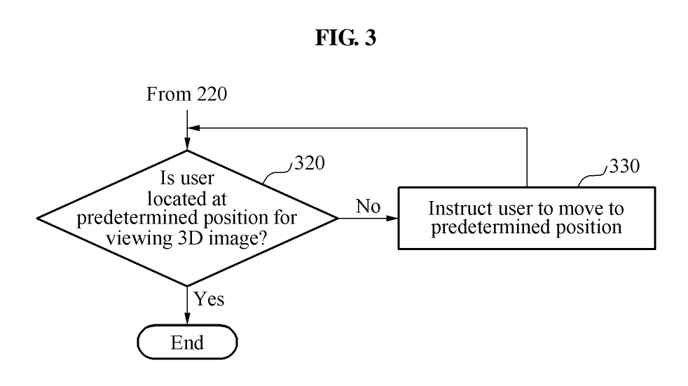

When a user viewing a 3D image different from the main image determined by the user determiner is to view the main image, the user may recognize an artifact with respect to the main image. In this example, the instructor 150 may instruct the user to move to the desired (or alternatively, predetermined) position such that the user views the main image without recognizing the artifact. Descriptions about a method of instructing a user to move to a desired (or alternatively, predetermined) position using the instructor 150 will also be provided with reference to FIGS. 3 through 9.

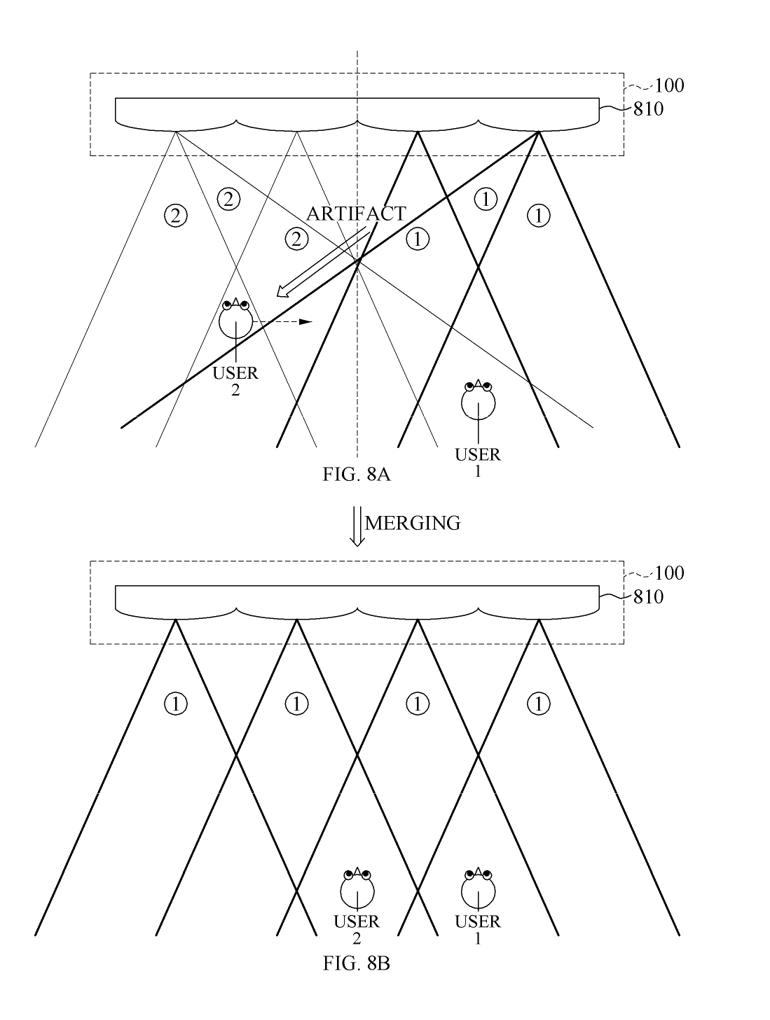

The image generator 110 may merge at least two images among the 3D images generated in the divided regions on the screen. For example, the image generator 110 may merge a 3D image being viewed by the main user determined by the user determiner 130 with another 3D image. The merging may be performed by merging the regions in which the 3D image is generated on the screen. Descriptions about a method of merging the generated 3D images using the image generator 110 will also be provided with reference to FIGS. 8A through 10.

Although not shown in FIG. 1, at least one function of the image generator 110, the controller 120, and the instructor 150 may be performed in the controller 120 provided in a single form. In this example, the controller 120 may be, for example, a core, a processor, or a chip provided in a single form or multiple forms. Also, at least one of the image generator 110, the user determiner 130, and the instructor 150 may be a module, a thread, a process, a service, a library, or a function performed by the controller 120.

FIG. 2 illustrates an example of an image processing method according to at least one example embodiment.

In operation 210, the user determiner 130 tracks a plurality of users viewing a 3D image displayed on a screen. For example, the user determiner 130 may track both eyes for each of the users viewing the 3D image displayed on the screen. The user determiner 130 may identify both eye positions for each of the users by tracking a position of a corresponding user, or identify a position for each of the users by tracking both eye positions of a corresponding user. The user determiner 130 may track the both eyes for each of the users sequentially or concurrently.

In operation 220, the image generator 110 generates a 3D image for each of a plurality of regions on the screen based on a result of the tracking. The regions may be formed by dividing the screen based on a number of the users. The image generator 110 may divide the screen into the plurality of regions, and generate 3D images in the divided regions. The image generator 110 may divide the screen into the plurality of regions based on the number of the users, and generate an optimized 3D image to be viewed by each of the users in each of the divided regions of the screen based on a result of the tracking the both eyes performed in operation 210. For example, the image generator 110 may divide the screen into the same number of regions as the number of users.

Each of the 3D images generated in the regions may be independent of one another. As an example, on the screen, a 3D image generated in a desired (or alternatively, predetermined) divided region may be independent of a 3D image generated in another desired (or alternatively, predetermined) divided region. For example, each of the 3D images generated in the regions may include identical or different contents.

Each of the 3D images generated in the regions on the screen may be a multiview stereo image.

The 3D image generated for each region on the screen may be related with (or associated with) at least one user. For example, the 3D image generated for each region on the screen may be appropriately generated to be viewed by the at least one user. The user determiner 130 may track the positions of the users viewing the generated 3D images, and the image generator 110 may generate 3D images for each of the divided areas on the screen based on the tracked positions such that the users appropriately view the 3D images. In a case of viewing the related 3D image, the position of the user may be included in a desired (or alternatively, predetermined) position, for example, an optimal viewing zone and thus, the user may view the 3D image without recognizing an artifact.

For example, a first image of the 3D images may be generated in a first region optimized to a first user among the regions on the screen, and a second image of the 3D images may be generated in a second region optimized to a second user among the regions on the screen. In this example, the first image may be related to (or associated with) the first user, and the second image may be related to (or associated with) the second user.

When all of the users are located at the desired (or alternatively, predetermined) position for viewing the 3D image, the image generator 110 may generate a 3D image without forming a plurality of regions. For example, when all of the users are located in an optimal viewing zone for viewing the 3D image, the image generator 110 may generate a 3D image on a full screen on which division is not performed (i.e., as though the plurality of regions is a single region).

Repeated descriptions will be omitted for increased clarity and conciseness because the descriptions provided with reference to FIG. 1 are also applicable to FIG. 2.

FIG. 3 illustrates another example of an image processing method according to at least one example embodiment.

In operation 320, the user determiner 130 may determine whether at least one user is located at a desired (or alternatively, predetermined) position for viewing at least one 3D image of 3D images generated for each of a plurality of divided regions, among a plurality of users viewing the generated 3D images. For example, the user determiner 130 may determine whether the at least one user is located at the desired (or alternatively, predetermined) position for viewing the at least one 3D image by tracking a position of the at least one user among the users viewing the generated 3D images. Whether the at least one user is located at the desired (or alternatively, predetermined) position may be determined based on whether an artifact is recognized when the at least one user views the at least one 3D image at a current position.

The user determiner 130 may determine whether a user is located at a desired (or alternatively, predetermined) position for viewing a 3D image unrelated to the user. For example, the user determiner 130 may determine whether the aforementioned second user is located at a desired (or alternatively, predetermined) first position for viewing the first image. In this example, the first region in which the first image viewed by the first user is generated may be adjacent to the second region in which the second image viewed by the second user is generated. The desired (or alternatively, predetermined) first position may be an optimal viewing zone of the first image. In the optimal viewing zone, the second user may view the first image without recognizing an artifact or simultaneously view the first image and the second image without recognizing the artifact.

In operation 330, the instructor 150 instructs the user to move to the desired (or alternatively, predetermined) position when the user is not located at the desired (or alternatively, predetermined) position for viewing the 3D image. For example, the instructor 150 may instruct the second user to move to the desired (or alternatively, predetermined) first position for viewing the first image. Alternatively, the instructor 150 may instruct a user related to the first region of the regions on the screen, to move to a desired (or alternatively, predetermined) position for viewing a 3D image of the second region when the user is not located at the desired (or alternatively, predetermined) position.

Also, when a user is not located at a desired (or alternatively, predetermined) position for viewing the main image or a desired (or alternatively, predetermined) position for viewing a 3D image related to the main user as described with reference to FIG. 1, the instructor 150 may instruct the user to move to the desired (or alternatively, predetermined) position. When the user moves to the desired (or alternatively, predetermined) position, the user may view the main image or the 3D image related to the main user without recognizing the artifact.

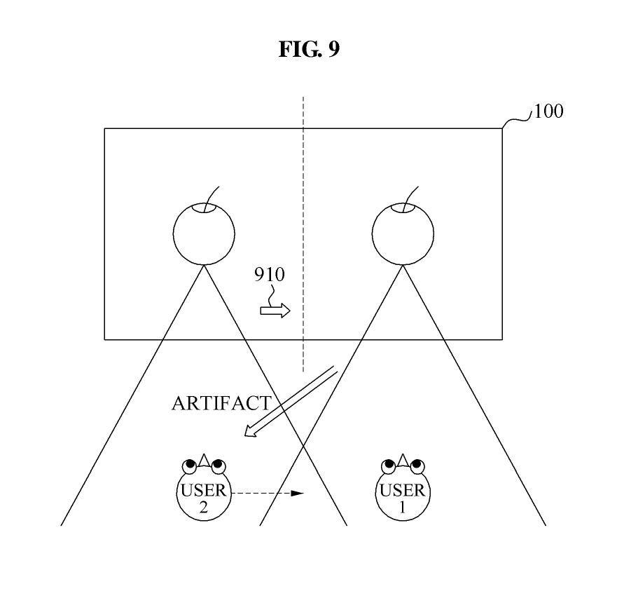

The instructor 150 may instruct the user to move to the desired (or alternatively, predetermined) position by outputting an indicator indicating the user is being instructed to move to the desired (or alternatively, predetermined) position on, for example, the screen. The indicator may be displayed on the screen such that the user is aware of a location of the desired (or alternatively, predetermined) position. In a case in which the user is to view the main image or the 3D image related to the main user, the indicator may be displayed on the screen in response to recognition of the artifact while the user is viewing the main image or the 3D image related to the main user at a current position. The indicator may not be output when the user is located at the desired (or alternatively, predetermined) position for viewing the main image or the 3D image related to the main user. Descriptions with respect to a method of instructing the user to move to the desired (or alternatively, predetermined) position using the instructor 150 will also be provided with reference to FIG. 9.

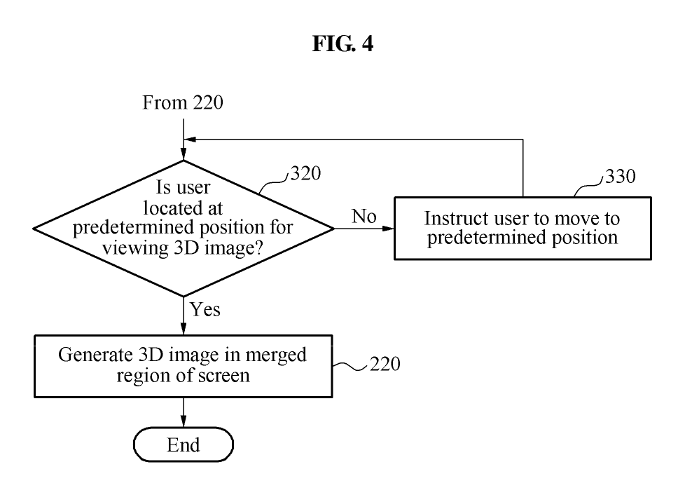

Descriptions about an operation performed by the image processing apparatus 100 when the user is located at the desired (or alternatively, predetermined) position for viewing the main image or the 3D image related to the main user will be provided with reference to FIG. 4.

Repeated descriptions will be omitted for increased clarity and conciseness because the descriptions provided with reference to FIGS. 1 and 2 are also applicable to FIG. 3.

FIG. 4 illustrates an example of a method of generating a 3D image in a merged region according to at least one example embodiment.

When the user is determined to be located at the desired (or alternatively, predetermined) position for viewing the 3D image in operation 320 of FIG. 3, operation 220 may be performed.

In operation 220, the image generator 110 may generate a 3D image when the user moves to the desired (or alternatively, predetermined) position or is determined as being located at the desired (or alternatively, predetermined) position. For example, when the second user of FIG. 2 is located at the first position or moves to the first position, the first image related to the first user and the second image related to the second user may be merged and formed into a 3D image. For example, when the user moves to the desired (or alternatively, predetermined) position, the image generator 110 may generate a 3D image related to the second region in a region in which the first region is merged with the second region.

Alternatively, when a user related to the first region of a plurality of regions is located at the desired (or alternatively, predetermined) position for viewing the 3D image of the second region, the image generator 110 may generate a 3D image related to the second region in the region in which the first region is merged with the second region.

In a process of merging 3D images, contents for each of the merged 3D images may be identical to one another. For example, in a process of merging the first image and the second image, contents of the first image related to the first user may be identical to contents of the second image related to the second user. Also, contents of an image related to the first region may be identical to contents of an image related to the second region.

Images may be merged by merging regions in which 3D images are generated, before the merging images is performed, and the merged image may be generated in a merged region in which the first and second regions are merged. For example, an image in which the first image is merged with the second image may be generated in a region in which the first region is merged with the second region.

The merging of the images may be performed independently of 3D images generated on the screen other than the merged 3D images. For example, the merging of the first image and the second image may be performed independently of 3D images generated in a plurality of regions on the screen other than the first image and the second image.

As an example, 3D images generated in at least three regions on the screen may be merged sequentially or concurrently.

The merging of the 3D images may be automatically performed based on a change in a position of the user.

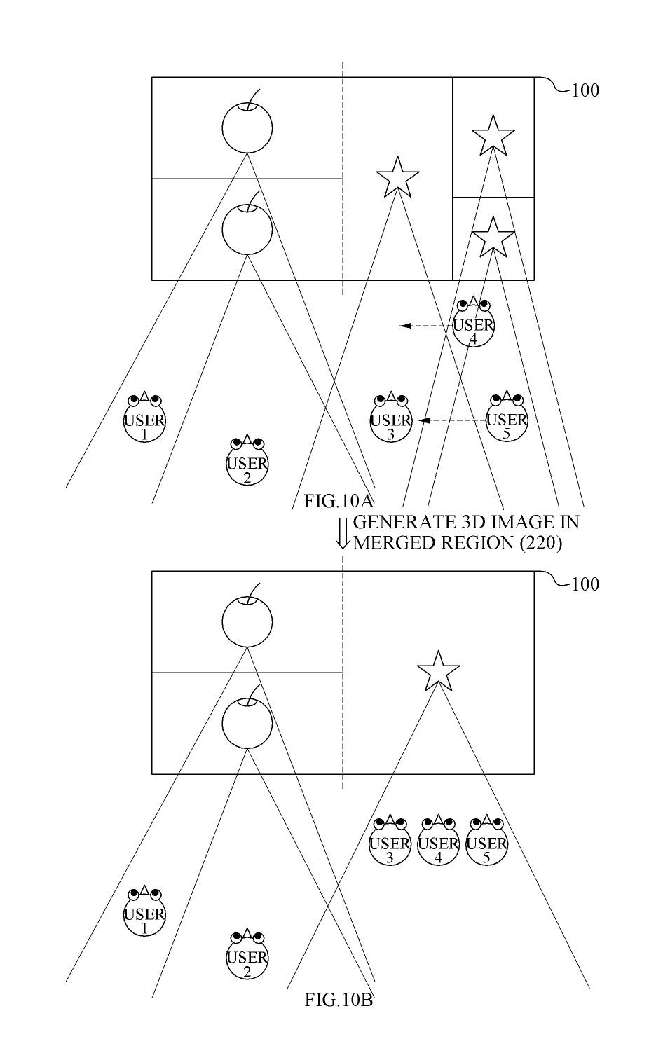

Descriptions with respect to a method of merging the images using the image generator 110 will also be provided with reference to FIGS. 8A, 8B and 10.

Repeated description will be omitted for increased clarity and conciseness because the description provided with reference to FIGS. 1 through 3 are also applicable to FIG. 4.

FIG. 5 illustrates an example of a method of determining a main image among 3D images generated on a screen according to at least one example embodiment.

In operation 510, the user determiner 130 determines the main image among 3D images generated by the image generator 110 in regions divided on the screen. The main image may be an image related to the desired (or alternatively, predetermined) position to which the user is instructed to move in operation 330 of FIG. 3. In this example, the main image may be a reference image used as a reference for viewing requested from the user when the instructor 150 instructs the user to move to the desired (or alternatively, predetermined) position. For example, in operation 320, the user determiner 130 may determine whether the user is located at the desired (or alternatively, predetermined) position for viewing the main image.

Also, the main image may be a reference image used as a reference for merging when the 3D images are merged in operation 220 of FIG. 4. For example, the merging may be performed among the main image and at least one another 3D image and thus, the merged image may include identical contents to contents of the main image. In an example of FIG. 2, the first image may be the main image between the first image and the second image. Alternatively, a 3D image related to the first region or a 3D image related to the second region may be determined as the main image.

Although not shown in FIG. 5, operation 510 may be performed subsequent to operation 210. For example, the user determiner 130 may determine the main image among the 3D images generated on the screen.

Repeated descriptions will be omitted for increased clarity and conciseness because the descriptions provided with reference to FIGS. 1 through 4 are also applicable to FIG. 5.

FIG. 6 illustrates an example of a method of determining a main user among a plurality of users viewing 3D images generated on a screen according to example embodiments.

In operation 610, the user determiner 130 determines a main user among a plurality of users viewing 3D images generated by the image generator 110 in regions divided on a screen. In a case in which the user is instructed to move to the desired (or alternatively, predetermined) position as described in operation 330 of FIG. 3, the main user may be a user related to a 3D image viewed at a desired (or alternatively, predetermined) position corresponding to an optimal viewing zone. For example, the main user may be a reference user related to a reference image to be viewed by a user in a case in which the instructor 150 instructs the user to move to the desired (or alternatively, predetermined) position. Thus, in operation 320, the user determiner 130 may determine whether at least one of the users other than the main user is located at the desired (or alternatively, predetermined) position for viewing the 3D image being viewed by the main user.

Also, the main user may be a reference user related to a 3D image used as a reference in a process of merging the 3D images as described in operation 220 of FIG. 4. For example, the merging may be performed among at least one another 3D image and the 3D image related to the main user and thus, the merged image may include contents identical to contents of the 3D image related to the main user. In FIG. 2, the first user may be the main user between the first user and the second user. Alternatively, a user related to the first region or a user related to the second region may be determined as the main user.

Accordingly, the user instructed by the instructor 150 may not correspond to the main user.

Repeated descriptions will be omitted for increased clarity and conciseness because the descriptions provided with reference to FIGS. 1 through 5 are also applicable to FIG. 6.

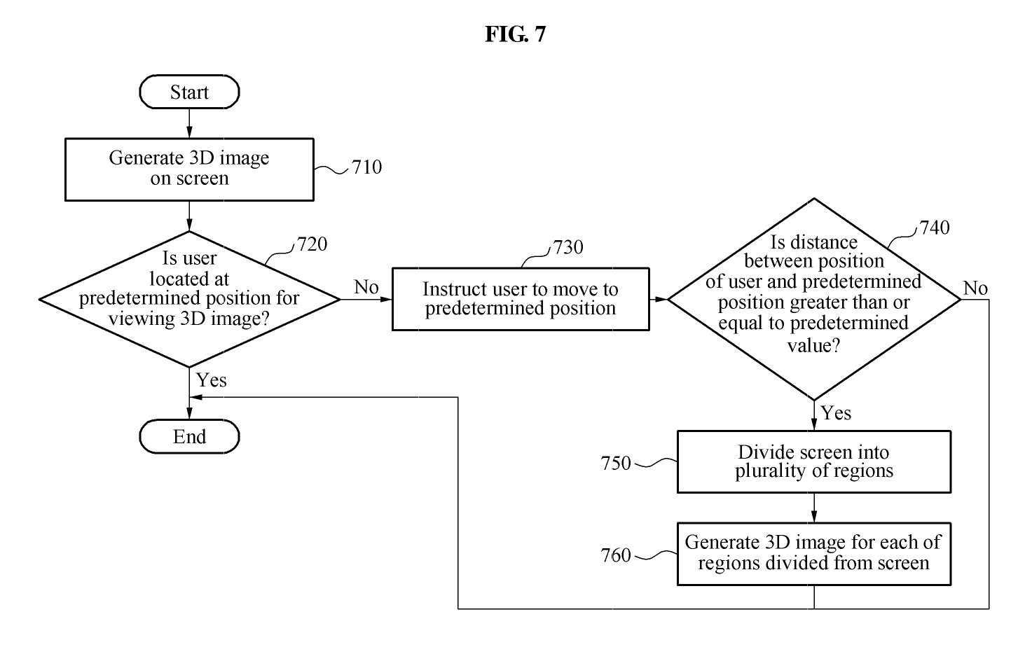

FIG. 7 illustrates still another example of an image processing method according to at least one example embodiment.

FIG. 7 illustrates an operation method of the image processing apparatus 100 of FIG. 1 based on another example.

In operation 710, the image generator 110 generates a 3D image on a screen. In this example, the screen may not be divided into a plurality of regions, and the 3D image may be generated in an overall region of the screen.

In operation 720, the user determiner 130 determines whether at least one user among a plurality of users viewing the generated 3D image is located at a desired (or alternatively, predetermined) position for viewing the 3D image generated on the screen. For example, the user determiner 130 may determine whether a user is located at an optimal (or desired) viewing zone for viewing a 3D image by tracking a position of the user.

In operation 730, the instructor 150 instructs the user to move to the desired (or alternatively, predetermined) position for viewing the 3D image when the user is not located at the desired (or alternatively, predetermined) position. For example, the instructor 150 may instruct the user to move to the desired (or alternatively, predetermined) position by outputting, on the screen, an indicator indicating the user to move to the desired (or alternatively, predetermined) position.

In operation 740, the user determiner 130 determines whether a distance between the tracked position of the user and the desired (or alternatively, predetermined) position is greater than or equal to a desired (or alternatively, predetermined) reference value (e.g., a reference distance). The reference value (or distance) may be user selected and/or based on empirical evidence. In a process of computing the distance, the desired (or alternatively, predetermined) position may indicate a center position of an optimal viewing zone in which the user views the 3D image.

In operation 750, the image generator 110 divides the screen into a plurality of regions when the distance between the tracked position of the user and the desired (or alternatively, predetermined) position is greater than or equal to the desired (or alternatively, predetermined) value. The screen may be divided into regions having forms appropriate for the users viewing the 3D image. Alternatively, the image generator 110 may divide the screen into the plurality of regions when the distance between the tracked position of the user and the desired (or alternatively, predetermined) position is greater than or equal to the desired (or alternatively, predetermined) value through a change in a position of the user.

In operation 760, the image generator 110 generates a 3D image for each of the regions divided appropriately for the user on the screen.

For example, the screen may be divided into the regions to have appropriate forms to be viewed by the users based on at least one of a distance between each of the users and the screen, and a tracked position for each of the user. The tracked position of the user may be included in the optimal viewing zone of the 3D image generated for each of the divided regions. Thus, the user may view the 3D image generated for each of the divided area without recognizing an artifact.

Contents of the 3D image generated for each of the divided area on the screen may be identical to the contents of the 3D image generated in operation 710.

Operation 760 may correspond to operation 210 of FIG. 2. Thus, the 3D images generated in the regions divided on the screen may be merged by performing operations 320, 330, and 220.

A division of the 3D image may be automatically performed based on the change in the position of the user.

Descriptions with respect to a method of dividing the screen into the plurality of regions and a method of generating the 3D images in the divided regions will also be provided with reference to FIGS. 8A through 10.

Repeated descriptions will be omitted for increased clarity and conciseness because the descriptions provided with reference to FIGS. 1 through 6 are also applicable to FIG. 7.

FIGS. 8A and 8B illustrate examples of an image processing method and a method of generating a 3D image in a merged region according to at least one example embodiment.

Referring to FIG. 8A, the image generator 110 may appropriately generate a 3D image \textcircled{1} and a 3D image \textcircled{2} for each of two regions divided from a screen such that a user 1 and a user 2 view the 3D image \textcircled{1} and the 3D image \textcircled{2}, respectively.

As an example, 3D images may be generated in regions divided from the screen using lenticular lenses 810. The lenticular lenses 810 may be fabricated in a form of a film or a sheet having a size corresponding to a size of the screen. A sheet or a film including the lenticular lenses 810 may be attached to a front side surface of the screen or a display panel. The lenticular lenses 810 may be, for example, electro-active lenticular lenses. An electro-active lenticular lens may be an electro-liquid crystal lens, and/or a lens through which a refractive index may be changed in response to applying a voltage to electro-liquid crystal molecules.

In FIGS. 8A and 8B, the 3D image \textcircled{1} may be a main image. Also, the user 1 viewing the 3D image \textcircled{1} may be a main user.

As illustrated in FIG. 8A, the user 2 wants to view the 3D image \textcircled{2} without recognizing an artifact. Because the user 2 is viewing part of the 3D image \textcircled{1}, the user 2 may recognize the artifact. In this example, the instructor 150 may instructor the user 2 to move to an optimal viewing zone of the 3D image \textcircled{1}. When the user 2 moves to the optimal viewing zone of the 3D image \textcircled{1}, the 3D image \textcircled{1} and the 3D image \textcircled{2} may be merged based on the 3D image \textcircled{1} as a reference.

As illustrated in FIG. 8B, the user 1 and the user 2 may view the 3D image \textcircled{1} without recognizing the artifact.

Repeated descriptions will be omitted for increased clarity and conciseness because the descriptions provided with reference to FIGS. 1 through 7 are also applicable to FIGS. 8A and 8B.

FIG. 9 illustrates an example of a method of instructing a user to move to a desired (or alternatively, predetermined) position for viewing a 3D image according to at least one example embodiment.

Referring to FIG. 9, the instructor 150 may instruct a user 2 to move to an optimal (or desired) viewing zone for viewing a 3D image related to a user 1 by outputting an indicator on a screen.

In FIG. 9, the user 1 may be a main user. Also, the 3D image related to the user 1 may be a main image.

When the user 2 is to view the 3D image related to the user 1, the user 2 may recognize an artifact, and identify an indicator 910 output on the screen. By moving based on an indication of the indicator 910, the user 1 may view the 3D image related to the user 1 without recognizing the artifact. As illustrated in FIG. 9, the indicator 910 may be expressed by, for example, an image of an arrow indicating a desired (or alternatively, predetermined) moving direction of the user 2. The indicator 910 may be displayed on the screen translucently so as not to obscure a line of sight of the user 2 viewing the 3D image.

Although not shown in FIG. 9, the indicator 910 may be provided in a form recognizable to the user 2 in lieu of displaying on the screen. As an example, the indicator 910 may be provided based on a visual method using, for example, a light emitting diode (LED) and an auditory method using, for example, a voice.

Repeated descriptions will be omitted for increased clarity and conciseness because the descriptions provided with reference to FIGS. 1 through 8B are also applicable to FIG. 9.

FIGS. 10A and 10B illustrate examples of a method of generating 3D images in regions divided on a screen and a method of generating a 3D image in a merged region according to at least one example embodiment.

As illustrated in FIGS. 10A and 10B, when a plurality of users view 3D images, a 3D image may be appropriately generated for each of regions divided from a screen to be viewed by each of the user. For example, the image generator 110 may generate a 3D image such that each of the users is located at an optimal (or desired) viewing zone of the 3D image.

The generated 3D image may be independent of another 3D image.

The image generator 110 may divide the screen into regions having different forms based on at least one of contents of the generated 3D image, a number of users viewing the 3D image, a distance between the screen and each of the users viewing the 3D image, and selections of the users viewing the 3D image. For example, the image generator 110 may divide the screen into the same number of regions as the number of users viewing the 3D image. The image generator 110 may divide the screen into regions in which 3D images are generated such that a size for each of the regions increases or decreases according to an increase in the distance between the screen and the each of the users viewing the 3D image. The image generator 110 may divide the screen into the regions in which 3D images are generated such that a size for each of the regions increases according to an increase in a complexity of the contents in the generated 3D image. Also, the image generator 110 may determine shapes and the number of regions to be divided from the screen based on the selections of the users (e.g., user selected viewing settings). As illustrated in FIGS. 10A and 10B, for example, the image generator 110 may vertically or horizontally divide the screen into the regions to appropriately generate 3D images to be viewed by the users. Also, the image generator 110 may diagonally divide the screen into the regions.

In FIG. 10A, a user 3 may be a main user. Also, a 3D image related to the user 3 may be a main image.

As described above, 3D images generated in at least three regions on the screen may be merged based on the main image or the 3D image related to the main user, sequentially or concurrently.

When a user 4 and a user 5 are to view the 3D image related to the user 3, the instructor 150 may instruct the user 4 and the user 5 to move to an optimal viewing zone of the 3D image related to the user 3.

As illustrated in FIG. 10B, when the user 4 and the user 5 move to the optimal viewing zone of the 3D image related to the user 3, 3D images related to the user 4 and the user 5 may be merged with the 3D image related to the user 3. The merging of the 3D images may be performed independently of 3D images being viewed by a user 1 and a user 2.

Repeated descriptions will be omitted for increased clarity and conciseness because the descriptions provided with reference to FIGS. 1 through 9 are also applicable to FIGS. 10A and 10B.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An image processing method comprising:
tracking users viewing a three-dimensional (3D) image displayed on a screen; and
generating a 3D image on the screen for each of a plurality of regions based on a result of the tracking, the plurality of regions being formed based on a number of the users.

2. The method of claim 1, wherein if a user associated with a first region of the plurality of regions is located at a desired position for viewing a 3D image of a second region of the plurality of regions, the generating generates the 3D image associated with the second region in a merged region by merging the first region with the second region.

3. The method of claim 1, further comprising:
instructing a user associated with a first region of the plurality of regions to move to a desired position for viewing a 3D image of a second region of the plurality of regions if the user is not located at the desired position.

4. The method of claim 3, wherein if the user moves to the desired position, the generating generates a 3D image associated with the second region in a merged region by merging the first region with the second region.

5. The method of claim 4, wherein contents of an image associated with the first region are identical to contents of an image associated with the second region.

6. The method of claim 4, wherein the 3D image associated with the second region is a main image.

7. The method of claim 4, wherein a user associated with the second region is a main user.

8. The method of claim 2, further comprising:
determining whether the user is located at the desired position based on whether the user recognizes an artifact in the 3D image.

9. The method of claim 3, further comprising:
outputting, to the user, an indicator instructing the user to move to the desired position such that the user is aware of a location of the desired position.

10. The method of claim 1, wherein if all of the users are located at a desired position for viewing the 3D image, the generating generates the 3D image as though the plurality of regions is a single region.

11. The method of claim 1, wherein the plurality of regions have different forms based on at least one of contents in the 3D image, the number of users viewing the 3D image, a distance between the screen and each of the users viewing the 3D image, and selections of the users viewing the 3D image.

12. A non-transitory computer-readable medium comprising program code that, when executed by a processor, performs functions according to the method of claim 1.

13. An image processing apparatus comprising:
a user determiner configured to track users viewing a three-dimensional (3D) image displayed on a screen; and
an image generator configured to generate a 3D image on the screen for each of a plurality of regions based on a result of the tracking, the plurality of regions being formed based on a number of the users.

14. The apparatus of claim 13, wherein if a user associated with a first region is located at a desired position for viewing a 3D image of a second region in the plurality of regions, the image generator is configured to generate a 3D image associated with the second region in a merged region by merging the first region with the second region.

15. The apparatus of claim 13, further comprising:
an instructor configured to instruct a user associated with a first region of the plurality of regions to move to a desired position for viewing a 3D image of a second region in the plurality of regions if the user is not located at a desired position.

16. The apparatus of claim 15, wherein if the user moves to the desired position, the image generator is configured to generate a 3D image associated with the second region in a merged region by merging the first region with the second region.

17. The apparatus of claim 16, wherein the user determiner is configured to determine that the 3D image associated with the second region is a main image.

18. The apparatus of claim 14, wherein the user determiner is configured to determine that a user associated with the second region is a main user.

19. The apparatus of claim 13, wherein if all of the users are located at a desired position for viewing a 3D image, the image generator is configured to generate the 3D image as though the plurality of regions is a single region.
